(19) United States
(12) Patent Application Publication
(10) Pub. No.: US 2022/0380701 A1
(43) Pub. Date: Dec. 1, 2022

(54) CLEANING COMPOSITIONS COMPRISING RENEWABLE COMPONENTS

(71) Applicant: The Procter & Gamble Company, Cincinnati, OH (US)

(72) Inventors: Gregory Leo JERVIER, Cincinnati, OH (US); Sarah Ann DELANEY, Hebron, KY (US)

(21) Appl. No.: 17/332,576

(22) Filed: May 27, 2021

(51) Int. Cl. C11D 1/14; C11D 1/90; C11D 1/83; C11D 1/66; C11D 3/20; C11D 11/00; C11D 17/00

(52) U.S. Cl. CPC C11D 1/146; C11D 1/90; C11D 1/83; C11D 1/662; C11D 3/2082; C11D 3/2086; C11D 11/0035; C11D 17/0008

(57) ABSTRACT

The present disclosure relates to cleaning compositions that comprise renewable components and fewer components, compared to traditional cleaning compositions, while providing comparable or better performance than traditional cleaning compositions.

### FIELD OF THE INVENTION

The present disclosure relates to cleaning compositions that comprise renewable components and fewer components, compared to traditional cleaning compositions, while providing comparable or better performance than traditional cleaning compositions.

### BACKGROUND OF THE INVENTION

There is increasing consumer demand for cleaning products that are more renewable or natural. Consumers also prefer cleaning products that contain a limited number of ingredients and/or recognizable natural ingredients, as communicated by simpler ingredient statements. However, these products are still expected to deliver performance on many attributes, such as cleaning and sudsing, comparable to traditional products.

Manual dishwashing detergents have been known in the art for decades. Modern manual dishwashing detergents often comprise a blend of surfactants that, although biodegradable, are synthetic and petroleum-based, along with numerous additional ingredients, such as solvents, detersive enzymes, polymers, and chelants, to improve cleaning performance and to achieve compositions that are consumer acceptable. Although major strides over decades have moved manual dishwashing detergents away from phosphates, many dishwashing detergents today contain synthetic, petroleum-based surfactants and a variety of additional ingredients, many of which are also synthetic. There is a need for manual dishwashing detergent compositions that includes natural ingredients and fewer overall ingredients, while still providing consumer acceptable performance.

Surprisingly, it has been found that an acidic composition comprising a limited number of mostly plant-based ingredients, more specifically, a limited number of mostly plant-based ingredients that includes an alkyl polyglucoside surfactant having an average alkyl carbon chain length of about 8 carbon atoms to about 10 carbon atoms, provides adequate cleaning performance and suds mileage, as well as acceptable viscosity, while maintaining stability across a range of temperatures, without the need for additional solvents or stabilizing aids.

### SUMMARY OF THE INVENTION

The present disclosure attempts to solve one or more of the needs by providing a liquid hand dishwashing cleaning composition comprising: a. from about 1% to about 40% by weight of the composition of a surfactant system comprising: i. from about 1% to about 20% by weight of the composition of an alkyl sulfate anionic surfactant of the formula R¹—O—SO₃M, wherein R¹ is a non-petroleum derived, linear fatty alcohol consisting of even numbered carbon chain lengths of from about C₆ to about C₂₀ and where M is an alkali metal, preferably Na or K, an earth alkali metal, preferably Mg, or ammonium or alkanolamine, preferably monoethanolamine, cation; ii. from about 1% to about 15% by weight of the composition of an alkyl polyglucoside surfactant, where the alkyl polyglucoside surfactant has an average alkyl carbon chain length of about 8 carbon atoms to about 10 carbon atoms and a number average degree of polymerization of from about 0.5 to about 3.0; iii. from about 1% to about 15% by weight of the composition of a zwitterionic surfactant; and b. water, where the pH of the composition is about 2 to about 7, at a 10% product solution in distilled water at 20° C. The present disclosure also relates to methods of manually washing dishware using such liquid hand dishwashing cleaning compositions.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, articles such as “a” and “an” when used in a claim, are understood to mean one or more of what is claimed or described.

As used herein, the terms “include”, “includes” and “including” are meant to be non-limiting.

The term “dishware” as used herein includes cookware and tableware made from, by nonlimiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease) saturated and unsaturated fats and oils, preferably oils and fats derived from animal sources such as beef, pig and/or chicken.

The term “renewable” is synonymous with the terms “natural,” “bio-derived”, “bio-based,” and means that a material is derived from substances derived from living organisms, such as farmed plants, rather than, for example, geologically derived, e.g., coal-derived or petroleum-derived.

“Geologically derived” means derived from, for example, petrochemicals, natural gas, or coal. “Geologically derived” materials cannot be easily replenished or regrown (e.g., in contrast to plant- or algae-produced materials).

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a cleaning composition relating to suds character during the dishwashing process. The term “sudsing profile” of a cleaning composition includes suds volume generated upon dissolving and agitation, typically manual agitation, of the cleaning composition in the aqueous washing solution, and the retention of the suds during the dishwashing process. Preferably, hand dishwashing cleaning compositions characterized as having “good sudsing profile” tend to have high suds volume and/or sustained suds volume, particularly during a substantial portion of or for the entire manual dishwashing process. This is important as the consumer uses high suds as an indicator that sufficient cleaning composition has been dosed. Moreover, the consumer also uses the sustained suds volume as an indicator that sufficient active cleaning ingredients (e.g., surfactants) are present, even towards the end of the dishwashing process. The consumer usually renews the washing solution when the sudsing subsides. Thus, a low sudsing cleaning composition will tend to be replaced by the consumer more frequently than is necessary because of the low sudsing level.

As used herein, the term “renewable component” refers to a component that is derived from renewable feedstock and contains renewable carbon. A renewable feedstock is a feedstock that is derived from a renewable resource, e.g., plants, and non-geologically derived. A material may be partially renewable (less than 100% renewable carbon content, from about 1% to about 90% renewable carbon content, or from about 1% to about 80% renewable carbon content, or from about 1% to about 60% renewable carbon content, or from about 1% to about 50% renewable carbon content) or 100% renewable (100% renewable carbon content). A renewable feedstock may be blended or chemically reacted with a geologically derived feedstock, resulting in a material with a renewable component and a geologically derived component.

“Renewable carbon” may be assessed using the “Assessment of the Biobased Content of Materials” method, ASTM D6866-16.

As used herein, the term “natural oils” means oils that are derived from plant or algae matter (also referred to as renewable oils). Natural oils are not based on kerosene or other fossil fuels. The term “oils” include fats, fatty acids, waste fats, oils, or mixtures thereof. Natural oils include, but are not limited to, coconut oil, babassu oil, castor oil, algae byproduct, beef tallow oil, borage oil, camelina oil, Canola® oil, choice white grease, coffee oil, corn oil, Cuphea viscosissima oil, evening primrose oil, fish oil, hemp oil, hepar oil, jatropha oil, Lesquerella fendleri oil, linseed oil, Moringa oleifera oil, mustard oil, neem oil, palm oil, perilla seed oil, poultry fat, rice bran oil, soybean oil, stillingia oil, sunflower oil, tung oil, yellow grease, cooking oil, and other vegetable, nut, or seed oils. A natural oil typically includes triglycerides, free fatty acids, or a combination of triglycerides and free fatty acids, and other trace compounds.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, less than about 0.25%, less than about 0.1%, less than about 0.05%, or less than about 0.01% by weight of the composition, of the component.

As used herein the term “dye” includes aesthetic dyes that modify the aesthetics of the cleaning composition as well as dyes and/or pigments that can deposit onto a dishware and alter the tint of the dishware. Dyes include colorants, pigments, and hueing agents.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Detergent Composition

The detergent compositions may have a form selected from liquid, powder, single-phase or multi-phase unit dose, pouch, tablet, gel, paste, bar, or flake, preferably the detergent compositions are liquids. The detergent composition may be a manual (hand) dishwashing detergent composition in liquid form. The cleaning composition is preferably an aqueous cleaning composition. The composition may comprise from about 50% to about 99%, preferably from about 60% to about 95%, more preferably from about 70% to about 85%, even more preferably from about 75% to about 80% by weight of the total composition of water.

The composition may be acidic. The pH of the composition may be from about 2.0 to about 7.0, preferably from about 2.5 to about 6.5, more preferably from about 3.0 to about 6.0, even more preferably from about 4.0 to about 6.0, as measured as a 10% finished product solution in distilled water at 20° C. The pH of the composition may be adjusted using pH modifying ingredients known in the art. The composition may have a reserve acidity to a pH of 7.00 of about 0.1 to about 3, preferably about 0.2 to about 2, more preferably about 0.3 to about 1. The composition may have a reserve alkalinity to a pH of 2.00 of about 1 to about 5, preferably about 1 to about 3, more preferably about 1.5 to about 2.5. The reserve alkalinity may contribute to the cleaning of tough food soils and the stability of the compositions. The reserve acidity may improve cleaning performance on hard water stains. The reserved alkalinity and reserved acidity are measured following the test methods described herein.

The composition of the present disclosure may be Newtonian or non-Newtonian, preferably Newtonian. The composition may have a viscosity of from about 50 mPa·s to about 5,000 mPa·s, preferably from about 300 mPa·s to about 2,000 mPa·s, more preferably from about 500 mPa·s to about 1,500 mPa·s, as measured on a Brookfield RT Viscometer using spindle 31, with the RPM of the viscometer adjusted to achieve a torque of between about 40% and about 60%, at 20° C.

The compositions of the present disclosure may comprise renewable components and exhibit good performance, such as cleaning and suds mileage. The compositions disclosed herein may comprise from about 1%, or from about 5%, or from about 10%, or from about 20% or from about 30%, of from about 40% or from about 50%, to about 40%, or to about 50%, or to about 60% or to about 70% or to about 80% or to about 90%, or to about 100% by weight of renewable components. The compositions disclosed herein may be at least partially or fully bio-based, As such, the composition can comprise a bio-based carbon content of about 50% to about 100%, preferably about 70% to about 100%, more preferably about 75% to about 100%, even more preferably about 80% to about 100%, most preferably about 90% to about 100%. The percent bio-based carbon content can be calculated as the “percent Modern Carbon (pMC)” as derived using the methodology of ASTM D6866-16. The compositions of the present disclosure may be substantially free of petroleum-derived solvents. The compositions of the present disclosure may be substantially free of surfactants or even polymers derived from petroleum-derived alcohols.

The compositions disclosed herein may have about 50% transmittance or greater, preferably about 75% transmittance or greater, more preferably about 90% transmittance or greater, of light using a 1 cm cuvette at wavelength of 410-800 nanometers. Alternatively, transparency of the composition may be measured as having an absorbency in the visible light wavelength (about 410 to 800 nm) of less than about 0.3, which is in turn equivalent to at least 50% transmittance using a cuvette and wavelength noted above. For purposes of the disclosure, as long as one wavelength in the visible light range has greater than 50% transmittance, it is considered to be transparent/translucent.

The compositions disclosed herein may be housed in containers that have about 25% transmittance or greater, preferably about 50% transmittance or greater, more preferably about 75% transmittance or greater, of light at a wavelength of about 410-800 nanometers.

The compositions disclosed herein may comprise less than about 15 ingredients, preferably less than about 10 ingredients, more preferably less than about 15 ingredients and greater than about 5 ingredients. The compositions of the present disclosure may be substantially free of dyes, enzymes, chelants, polymers, monoethanolamine, or a combination thereof.

Surfactant System

The detergent composition(s) of the present disclosure may comprise from about 1% to about 40%, preferably from about 5% to about 38%, more preferably from about 10% to about 35%, even more preferably from about 10% to about 25% or about 15% to about 25% by weight of the total composition of a surfactant system. The surfactant system may comprise an anionic surfactant, an alkyl polyglucoside surfactant, and a co-surfactant.

Anionic Surfactant

The surfactant system may comprise an anionic surfactant. The anionic surfactant may comprise at least about 50%, preferably at least about 70%, more preferably at least about 90% by weight of the anionic surfactant of alkyl sulfate anionic surfactant. Most preferably, the anionic surfactant consists of alkyl sulfate surfactant, most preferably primary alkyl sulfate anionic surfactant. As such, while the surfactant system may comprise small amounts of further anionic surfactant, including sulfonates such as HLAS, or sulfosuccinate anionic surfactants, the surfactant system preferably comprises no further anionic surfactant beyond the alkyl sulfate anionic surfactant. Preferably the alkyl sulfate anionic surfactant is a non-alkoxylated alkyl sulfate anionic surfactant, most preferably a non-alkoxylated primary alkyl sulfate anionic surfactant.

The detergent compositions described herein may comprise from about 1% to about 20%, preferably about 4% to about 16%, more preferably about 7% to about 13%, by weight of the composition, of alkyl sulfate anionic surfactant. The alkyl sulfate anionic surfactant may be derived from renewable fatty alcohol.

The detergent compositions described herein may comprise one or more alkyl sulfate anionic surfactants of the formula R¹—O—SO₃M, where R¹ is a non-petroleum derived, linear fatty alcohol consisting of even numbered carbon chain lengths of from about C₆ to about C₂₀, preferably from about C₈ to about C₁₈, more preferably from about C₈ to about C₁₆, where M is an alkali metal, preferably Na or K, an earth alkali metal, preferably Mg, or ammonium or alkanolamine, preferably monoethanolamine, cation.

The fatty alcohol portion of the alkyl sulfate (R¹) is derived from a renewable source (e.g., plant derived) rather than geologically derived (e.g., petroleum derived). Fatty alcohols derived from a renewable source may be referred to as natural fatty alcohols. Natural fatty alcohols are linear and have an even number of carbon atoms with a single alcohol (—OH) attached to the terminal carbon. The fatty alcohol portion of the surfactant (R¹) may comprise distributions of even number carbon chains, e.g., C8, C10, C12, C14, C16, C18, and so forth. The fatty alcohol portion of the surfactant (R¹) may comprise a single even number chain length, e.g., C12 only. For example, using a single chain length alcohol as starting material, a corresponding single chain length alkyl sulfate will result. Though, it may be advisable to utilize mixtures of alcohols having a distribution of carbon chain length around a selected mean. This will, of course, provide a mixture of alkyl sulfates having the same distribution of chain lengths around the mean. The fatty alcohol portion of the surfactant (R¹) may comprise C12-C14 chains.

The fatty alcohol portion of the alkyl sulfate (R¹) may be derived from a natural oil. The natural oil may be selected from the group consisting of coconut oil, palm kernel oil, palm oil, or a mixture thereof. These oils contain the greatest concentration of triglycerides and free fatty acids having chain lengths ranging from C10 to C18, particularly C10 to C16. The natural oil may comprise triglycerides and free fatty acids in the C10 to C18 chain length or in the C10 to C16 chain length.

The compositions disclosed herein may comprise one or more than one type of alkyl sulfates; the different types of alkyl sulfate may differ in carbon chain length distribution and number average carbon chain length. The compositions disclosed herein may be a single sourced alkyl sulfate or may comprise a mixture of alkyl sulfates, where the single sourced material or mixture may have a number average (arithmetic mean) carbon chain length within the range of about 10 to about 16 carbon atoms, preferably about 12 carbon atoms to about 14 carbon atoms. It is understood that an alkyl sulfate anionic surfactant of the formula R¹—O—SO₃M, where R¹ is a non-petroleum derived, linear fatty alcohol consisting of even numbered carbon chain lengths of from about C₆ to about C₂%, may be a single chain length surfactant, e.g., CH₃(CH₂)₁₁—O—SO₃M, or a subfraction of chain lengths, preferably a C12-C14 subfraction. Preferably, a single sourced alkyl sulfate is used, fractionated to maximize the C12 and C14 alkyl chain lengths.

Alkyl Polyglucoside Surfactant

The surfactant system may comprise an alkyl polyglucoside surfactant. Alkyl polyglucosides are nonionic surfactants. Alkyl polyglucosides are typically more sudsing than other nonionic surfactants, such as alkyl ethoxylated alcohols.

The detergent compositions described herein may comprise from about 1% to about 15%, preferably about 2.0% to about 10%, more preferably about 3.0% to about 7.0%, by weight of the composition of alkyl polyglucoside surfactant.

A combination of alkyl polyglucoside and alkyl sulfate anionic surfactant has been found to provide improved polymerized grease removal, suds mileage performance, reduced viscosity variation with changes in the surfactant and/or system, and a more sustained Newtonian rheology. The alkyl polyglucoside surfactant can be selected from C6-C12 alkyl polyglucoside surfactant, preferably C8-C10 alkyl polyglucoside surfactant. The alkyl polyglucoside surfactant can have a number average degree of polymerization of from 0.1 to 3.0, preferably from 0.5 to 3.0, more preferably from 1.0 to 2.0. The alkyl polyglucoside surfactant may have a number average carbon chain length of about 8 carbon atoms to about 10 carbon atoms. At least 90%, preferably at least 95%, more preferably at least 98%, by weight of the alkyl polyglucoside surfactant may have a carbon chain length of about 8 to about 10 carbon atoms. Surprisingly, it has been found that alkyl polyglucoside surfactants having an average alkyl carbon chain length of about 8 carbon atoms to about 10 carbon atoms provide advantages over other APGs having different chain lengths, namely acceptable viscosity and improved foaming and detergency.

The weight ratio of alkyl sulfate anionic surfactant to alkyl polyglucoside surfactant may be from about 1:1 to about 10:1, preferably from about 1.5:1 to about 5:1. Glucopon® 215UP is a preferred C8-C10 alkyl polyglucoside surfactant.

Co-Surfactant

In order to improve surfactant packing after dilution and hence improve suds mileage, the surfactant system may further comprise a co-surfactant. Preferred co-surfactants are selected from the group consisting of an amphoteric surfactant, a zwitterionic surfactant, and mixtures thereof. The co-surfactant is preferably a zwitterionic surfactant, more preferably betaine surfactant. The weight ratio of alkyl sulfate anionic surfactant to zwitterionic surfactant may be from about 1:1 to about 10:1, preferably from about 1.5:1 to about 5:1.

The detergent compositions described herein may comprise from about 1% to about 15%, preferably about 1.5% to about 10%, more preferably about 2.0% to about 5.0%, by weight of the composition of a zwitterionic surfactant.

Suitable zwitterionic surfactants include betaine surfactants. Such betaine surfactants includes alkyl betaines, alkylamidobetaine, amidazoliniumbetaine, sulphobetaine (INCI Sultaines) as well as the phosphobetaine, and preferably meets formula (I):

R¹—[CO—X(CH₂)ₙ]ₓ—N⁺(R²)(R³)—(CH₂)ₘ—[CH(OH)—CH₂]_{y}—Y⁻

wherein in formula (I),

R¹ is selected from the group consisting of: a saturated or unsaturated C6-22 alkyl residue, preferably C8-18 alkyl residue, more preferably a saturated C10-16 alkyl residue, most preferably a saturated C12-14 alkyl residue;

X is selected from the group consisting of: NH, NR⁴ wherein R¹ is a C1-4 alkyl residue, O, and S,

n is an integer from 1 to 10, preferably 2 to 5, more preferably 3,

x is 0 or 1, preferably 1,

R² and R³ are independently selected from the group consisting of: a C1-4 alkyl residue, hydroxy substituted such as a hydroxyethyl, and mixtures thereof, preferably both R² and R³ are methyl,

m is an integer from 1 to 4, preferably 1, 2 or 3,

y is 0 or 1, and

Y is selected from the group consisting of: COO, SO₃, OPO(OR⁵)O or P(O)(OR⁵)O, where R⁵ is H or a C1-4 alkyl residue.

Preferred betaines are the alkyl betaines of formula (Ha), the alkyl amido propyl betaine of formula (IIb), the sulphobetaines of formula (IIc) and the amido sulphobetaine of formula (IId):

R¹—N+(CH₃)₂—CH₂COO⁻ (IIa)

R¹—CO—NH—(CH₂)₃—N+(CH₃)₂—CH₂COO⁻ (IIb)

R¹—N+(CH₃)₂—CH₂CH(OH)CH₂SO₃⁻ (IIc)

R¹—CO—NH—(CH₂)₃—N+(CH₃)₂—CH₂CH(OH)CH₂SO₃⁻ (IId)

in which R¹ has the same meaning as in formula (I). Particularly preferred are the carbobetaines [i.e. where Y⁻═COO⁻ in formula (I)] of formulae (IIa) and (IIb), more preferred are the alkyl betaines of formula (IIa) and the alkylamidobetaine of formula (IIb).

Preferably, the betaine surfactant is selected from the group consisting of: alkyl betaines, alkyl amidopropylbetaines, and mixtures thereof, more preferably the betaine surfactant is an alkylamidopropylbetaine surfactant. Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kernelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. More preferred betaines are selected from the group consisting of lauramidopropyl betaine, myristyl amidopropylbetaine, cocoamidopropylbetaine, and mixtures thereof. Lauramidopropyl betaine is particularly preferred.

The weight ratio of zwitterionic surfactant to alkyl polyglucoside surfactant may be from about 5:1 to about 1:5, preferably from about 2:1 to about 1:4, more preferably from about 1:1 to about 1:3.

Carboxylic Acid or Salt Thereof

The detergent compositions described herein may comprise from about 0.1% to about 10%, preferably about 1% to about 8.5%, more preferably about 2.0% to about 5.0%, by weight of the composition of a carboxylic acid or a salt thereof. The detergent compositions described herein may comprise from about 0.01% to about 1%, preferably from about 0.01% to about 0.1%, by weight of the composition of acetic acid.

The carboxylic acid or a salt thereof may be selected from the group consisting of citric acid, oxalic acid, sorbic acid, acetic acid, tartaric acid, formic acid, maleic acid, adipic acid, lactic acid, malic acid, malonic acid, glycolic acid, propanoic acid, propionic acid, salicylic acid, benzoic acid, orthohydroxy benzoic acid, salts thereof, and mixtures thereof, more preferably the carboxylic acid or a salt thereof is selected from the group consisting of citric acid, acetic acid, lactic acid, salts thereof, and mixtures thereof, even more preferably the carboxylic acid or a salt thereof is selected from the group consisting of citric acid, acetic acid, salts thereof, and mixtures thereof.

The composition of the present invention may further comprise at least one ingredient selected from the group consisting of salts, hydrotropes, organic solvents, perfumes, and mixtures thereof.

Salt:

The compositions disclosed herein may comprise from 0.05% to 2%, or preferably from 0.1% to 1.5%, or more preferably from 0.5% to 1%, by weight of the total composition of a salt, preferably a monovalent or divalent inorganic salt, or a mixture thereof, more preferably selected from the group consisting of sodium chloride, sodium sulfate, and mixtures thereof. Sodium chloride is preferred.

Hydrotrope:

The compositions disclosed herein may comprise from 0.1% to 10%, or preferably from 0.5% to 10%, or more preferably from 1% to 10% by weight of the total composition of a hydrotrope or a mixture thereof, such as sodium cumene sulfonate. Preferably the composition is substantially free of petroleum derived hydrotropes.

Organic Solvent:

The compositions disclosed herein may comprise from 0.1% to 10%, or preferably from 0.5% to 10%, or more preferably from 1% to 10% by weight of the total composition of an organic solvent. Suitable organic solvents include organic solvents selected from the group consisting of polyols, such as glycerol or a glycol (e.g., polyalkyleneglycols), alcohols, glycol ethers, and mixtures thereof, preferably selected from the group consisting of glycerol, ethanol polypropyleneglycol (PPG), and mixtures thereof. The polypropyleneglycol can have a molecular weight of from 400 to 3000, preferably from 600 to 1500, more preferably from 700 to 1300. The polypropyleneglycol is preferably poly-1,2-propyleneglycol. Preferably the composition is substantially free of petroleum-derived solvents.

Perfume:

The compositions disclosed herein may comprise a perfume. The compositions may comprise from about 0.1% to about 3%, preferably from about 0.25% to about 2%, more preferably from about 0.5% to about 1.5% by weight of the total composition of a perfume. The compositions may comprise a natural perfume, preferably the natural perfume comprises a natural essential oil, more preferably the natural essential oil is selected from the group consisting of lemon oil, rosemary oil, thyme oil, clove oil, cinnamon oil, geranium oil, eucalyptus oil, peppermint oil, mint oil, and mixtures thereof. The compositions disclosed herein may be substantially free of synthetic perfume. As used herein, “natural perfumes” are perfumes that contain no synthetic ingredients and “synthetic perfumes” are perfumes that contain one or more synthetic ingredients. Perfume ingredients may include natural products such as extracts, essential oils, absolutes, resinoids, resins, concretes etc., and also synthetic basic substances such as hydrocarbons, alcohols, aldehydes, ketones, ethers, acids, esters, acetals, ketals, nitriles, etc., including saturated and unsaturated compounds, aliphatic, carbocyclic and heterocyclic compounds.

Method of Washing

The compositions of the present disclosure may be used in methods of manually washing dishware. Suitable methods can include the steps of delivering a composition of the present disclosure to a volume of water to form a wash solution and immersing the dishware in the solution. The dishware is cleaned with the composition in the presence of water. Typically from 0.5 mL to 20 mL, preferably from 3 mL to 10 mL of the detergent composition, preferably in liquid form, can be added to the water to form the wash liquor. The actual amount of detergent composition used will be based on the judgment of the user, and will typically depend upon factors such as the particular product formulation of the detergent composition, including the concentration of active ingredients in the detergent composition, the number of soiled dishes to be cleaned, the degree of soiling on the dishes, and the like.

The detergent compositions may be combined with from 2.0 L to 20 L, typically from 5.0 L to 15 L of water to form a wash liquor, such as in a sink. The soiled dishware is immersed in the wash liquor obtained, before scrubbing the soiled surface of the dishware with a cloth, sponge, or similar cleaning implement. The cloth, sponge, or similar cleaning implement is typically contacted with the dishware for a period of time ranged from 1 to 10 seconds, although the actual time will vary with each application and user preferences.

Optionally, the dishware can be subsequently rinsed. By “rinsing”, it is meant herein contacting the dishware cleaned with the process according to the present invention with substantial quantities water. By “substantial quantities”, it is meant usually from 1.0 to 20 L, or under running water.

Alternatively, the composition herein can be applied in its neat form to the dishware to be treated. By “in its neat form”, it is meant herein that said composition is applied directly onto the surface to be treated, or onto a cleaning device or implement such as a brush, a sponge, a nonwoven material, or a woven material, without undergoing any significant dilution by the user (immediately) prior to application. “In its neat form”, also includes slight dilutions, for instance, arising from the presence of water on the cleaning device, or the addition of water by the consumer to remove the remaining quantities of the composition from a bottle. Therefore, the composition in its neat form includes mixtures having the composition and water at ratios ranging from 50:50 to 100:0, preferably 70:30 to 100:0, more preferably 80:20 to 100:0, even more preferably 90:10 to 100:0 depending on the user habits and the cleaning task.

Such methods of neat application comprise the step of contacting the liquid hand dishwashing detergent composition in its neat form, with the dish. The composition may be poured directly onto the dish from its container. Alternatively, the composition may be applied first to a cleaning device or implement such as a brush, a sponge, a nonwoven material, or a woven material. The cleaning device or implement, and consequently the liquid dishwashing composition in its neat form, is then directly contacted to the surface of each of the soiled dishes, to remove said soiling. The cleaning device or implement is typically contacted with each dish surface for a period of time range from 1 to 10 seconds, although the actual time of application will depend upon factors such as the degree of soiling of the dish. The contacting of said cleaning device or implement to the dish surface is preferably accompanied by concurrent scrubbing.

Subsequently, the dishware can be rinsed, either by submersing in clean water or under running water.

### Combinations

A. A liquid hand dishwashing cleaning composition comprising:
   a. from about 1% to about 40% by weight of the composition of a surfactant system comprising:
      i. from about 1% to about 20%, preferably about 4% to about 16%, more preferably about 7% to about 13%, by weight of the composition of an alkyl sulfate anionic surfactant of the formula R¹—O—SO₃M, wherein R¹ is a non-petroleum derived, linear fatty alcohol consisting of even numbered carbon chain lengths of from about C₆ to about C₂₀ and where M is an alkali metal, preferably Na or K, an earth alkali metal, preferably Mg, or ammonium or alkanolamine, preferably monoethanolamine, cation, or mixtures thereof;
      ii. from about 1% to about 15%, preferably about 2% to about 10%, more preferably about 3.0% to about 7.0%, by weight of the composition of an alkyl polyglucoside surfactant, wherein the alkyl polyglucoside surfactant has an average alkyl carbon chain length of about 8 carbon atoms to about 10 carbon atoms and a number average degree of polymerization of from about 0.5 to about 3.0;
      iii. from about 1% to about 15%, preferably about 1.5% to about 10%, more preferably about 2.0% to about 5.0%, by weight of the composition of a zwitterionic surfactant; and
   b. water;
   wherein the pH of the composition is about 2 to about 7, preferably about 2.5 to about 6.5, more preferably about 3 to about 6, even more preferably about 4 to about 6, measured as a 10% finished product solution in distilled water at 20° C.
B. The liquid hand dishwashing cleaning composition according to Paragraph A, wherein the composition comprises from about 0.1% to about 10%, preferably about 1.0% to about 8.5%, more preferably about 2.0% to about 5.0%, by weight of the composition of a carboxylic acid or a salt thereof, preferably the carboxylic acid or a salt thereof is selected from the group consisting of citric acid, oxalic acid, sorbic acid, acetic acid, tartaric acid, formic acid, maleic acid, adipic acid, lactic acid, malic acid, malonic acid, glycolic acid, propanoic acid, propionic acid, salicylic acid, benzoic acid, succinic acid, orthohydroxy benzoic acid, salts thereof, and mixtures thereof, more preferably the carboxylic acid or a salt thereof is selected from the group consisting of citric acid, lactic acid, salts thereof, and mixtures thereof, most preferably the carboxylic acid or a salt thereof is selected from the group consisting of citric acid, a salt thereof, and mixtures thereof.
C. The liquid hand dishwashing cleaning composition according to Paragraph A, wherein the alkyl sulfate anionic surfactant has an average alkyl carbon chain length of about 10 carbon atoms to about 16 carbon atoms, preferably about 12 carbon atoms to about 14 carbon atoms.
D. The liquid hand dishwashing cleaning composition according to any one of the preceding Paragraphs, wherein at least 90%, preferably at least 95%, more preferably at least 98%, by weight of the alkyl polyglucoside surfactant has a carbon chain length of about 8 to about 10 carbon atoms.
E. The liquid hand dishwashing cleaning composition according to any one of the preceding Paragraphs, wherein the weight ratio of C₈ alkyl polyglucoside to C₁₀ alkyl polyglucoside is from about 40:60 to about 60:40.
F. The liquid hand dishwashing cleaning composition according to any one of the preceding Paragraphs, wherein the composition is substantially free of dyes, enzymes, polymers, or a combination thereof.
G. The liquid hand dishwashing cleaning composition according to any one of the preceding Paragraphs, wherein the composition is substantially free of petroleum-derived solvents.
H. The liquid hand dishwashing cleaning composition according to any one of the preceding Paragraphs, wherein the composition is substantially free of surfactants derived from petroleum-derived alcohols.
I. The liquid hand dishwashing cleaning composition according to any one of the preceding Paragraphs, wherein the alkyl polyglucoside surfactant has a number average degree of polymerization of from about 1.0 to about 2.0.
J. The liquid hand dishwashing cleaning composition according to any one of the preceding Paragraphs, wherein the zwitterionic surfactant comprises, preferably consists of, betaine surfactant, preferably the betaine surfactant is selected from the group consisting of: alkyl betaines, alkyl amidopropylbetaines, and mixtures thereof, preferably selected from cocoamidopropyl betaine, cocobetaines, lauramidopropyl betaine, lauryl betaine, myristyl amidopropyl betaine, myristyl betaine, and mixtures thereof, more preferably the betaine surfactant is an alkylamidopropylbetaine surfactant, most preferably selected from lauramidopropyl betaine, myristyl amidopropylbetaine, cocoamidopropylbetaine, or mixtures thereof.
K. The liquid hand dishwashing cleaning composition according to any one of the preceding Paragraphs, wherein the composition has about 50% transmittance or greater, preferably about 75% transmittance or greater, more preferably about 90% transmittance or greater, of light using a 1 cm cuvette at a wavelength of 410-800 nanometers.
L. The liquid hand dishwashing cleaning composition according to any one of the preceding Paragraphs, wherein the composition is housed in a container that has about 25% transmittance or greater, preferably about 50% transmittance or greater, more preferably about 75% transmittance or greater, of light at a wavelength of about 410-800 nanometers.
M. The liquid hand dishwashing cleaning composition according to any one of the preceding Paragraphs, wherein the weight ratio of alkyl sulfate anionic surfactant to zwitterionic surfactant is from about 1:1 to about 10:1, preferably from about 1.5:1 to about 5:1.
N. The liquid hand dishwashing cleaning composition according to any one of the preceding Paragraphs, wherein the weight ratio of alkyl sulfate anionic surfactant to alkyl polyglucoside surfactant is from about 1:1 to about 10:1, preferably from about 1.5:1 to about 5:1.
O. The liquid hand dishwashing cleaning composition according to any one of the preceding Paragraphs, wherein the weight ratio of zwitterionic surfactant to alkyl polyglucoside surfactant is from about 5:1 to about 1:5, preferably from about 2:1 to about 1:4, more preferably from about 1:1 to about 1:3.
P. The liquid hand dishwashing cleaning composition according to any one of the preceding Paragraphs, wherein the composition has a viscosity of from about 50 mPa·s to about 5,000 mPa·s, preferably from about 300 mPa·s to about 2,000 mPa·s, more preferably from about 500 mPa-s to about 1,500 mPa·s, as measured on a Brookfield RT Viscometer using spindle 31, with the RPM of the viscometer adjusted to achieve a torque of between about 40% and about 60%, at about 20° C.
Q. The liquid hand dishwashing cleaning composition according to any one of the preceding Paragraphs, wherein the cleaning composition comprises less than 15 ingredients, preferably less than 10 ingredients, more preferably less than 10 ingredients and greater than 5 ingredients.
R. The liquid hand dishwashing cleaning composition according to any one of the preceding Paragraphs, wherein the cleaning composition further comprises acetic acid and/or a salt thereof, preferably the concentration of acetic acid and/or a salt thereof is about 0.01% to about 1%, more preferably about 0.01% to about 0.1%, by weight of the composition.
S. The liquid hand dishwashing cleaning composition according to any one of the preceding Paragraphs, wherein the cleaning composition comprises a natural perfume, preferably the natural perfume comprises a natural essential oil, more preferably the natural essential oil is selected from the group consisting of lemon oil, rosemary oil, lavender oil, thyme oil, clove oil, cinnamon oil, geranium oil, eucalyptus oil, peppermint oil, mint oil, and mixtures thereof.
T. The liquid hand dishwashing cleaning composition according to any one of the preceding Paragraphs, wherein the composition is substantially free of a synthetic perfume.
U. The liquid hand dishwashing cleaning composition according to any one of the preceding Paragraphs, wherein the composition has a reserve acidity to a pH of 7.00 of about 0.1 to about 3, preferably about 0.2 to about 2, more preferably about 0.3 to about 1.
V. The liquid hand dishwashing cleaning composition according to any one of the preceding Paragraphs, wherein the composition has a reserve alkalinity to a pH of 2.00 of about 1 to about 5, preferably about 1 to about 3, more preferably about 1.5 to about 2.5.
W. The liquid hand dishwashing cleaning composition according to any one of the preceding Paragraphs, wherein the composition comprises a bio-based carbon content of about 50% to about 100%, preferably about 70% to about 100%, more preferably about 75% to about 100%, even more preferably about 80% to about 100%, most preferably about 90% to about 100%, as derived using ASTM D6866-16.
X. The liquid hand dishwashing cleaning composition according to any one of the preceding Paragraphs, wherein the composition comprises from about 50% to about 99%, preferably from about 60% to about 95%, more preferably from about 70% to about 85%, even more preferably from about 75% to about 80% by weight of the composition of water.
Y. A method of manually washing dishware comprising: i) delivering a liquid hand dishwashing cleaning composition according to any one of the preceding Paragraphs onto the dishware or a cleaning implement; ii) cleaning the dishware with the composition in the presence of water, and iii) optionally, rinsing the dishware.
Z. A method of manually washing dishware comprising: i) providing a liquid hand dishwashing cleaning composition according to any one of Paragraphs A-X; ii) diluting said liquid hand dishwashing cleaning composition in water to obtain a wash solution, wherein the water preferably has hardness of about 6 grains per gallon to about 12 grains per gallon; and iii) washing dishware with the wash solution; iv) optionally, rinsing the dishware.

Test Methods

Viscosity:

The viscosity is measured at 20° C. using a Brookfield RT Viscometer using spindle 31 with the RPM of the viscometer adjusted to achieve a torque of between 40% and 60%.

The viscosity profile upon shearing, as shown in the examples section, is measured at 20° C. using a Discovery HR-1 Hybrid Rheometer (TA Instruments) using a shear-rate sweep of from 0.10-1 to 1000 s-1, after a 30 second zero-shear equilibration step.

Reserve Alkalinity:

Reserve alkalinity is defined as the grams of NaOH per 100 g or percent of composition required to titrate the test composition at pH 2 to come to the test composition pH. The reserve alkalinity for a solution is determined in the following manner. A pH meter (for example An Orion Model 720A) with a Ag/AgCl electrode (for example an Orion sure flow Electrode model 9172BN) is calibrated using standardized pH 1, pH 2 and pH 4 buffers. A 100 g of a 10% solution in distilled water at 20° C. of the composition to be tested is prepared. The pH of the 10% solution is measured and the 100 g solution is titrated down to pH 2 using a standardized solution of 0.1 N of HCl. The volume of 0.1N HCl required is recorded in ml. The reserve alkalinity is calculated as follows: Reserve Alkalinity=ml HCl×0.1 Normality (equivalent/liter)×Equivalent weight NaOH (g/equivalent)×100%/sample wt. (g)/1000.

Reserve Acidity:

Reserve acidity is defined as the grams of NaOH per 100 g or percent of product required to attain a pH of 7.00. The reserve acidity measurement as used herein is based upon titration (at standard temperature and pressure) of a 1% product solution in distilled water to an end point of pH 7.00, using standardized NaOH solution. Reserve acidity=ml NaOH×Normality (equivalent/liter)×Equivalent weight NaOH (g/equivalent)×100%/sample wt. (g)/1000.

### EXAMPLE

### Example 1—Viscosities of Liquid Hand Dish Detergent Compositions

The five formulations in Table 1 are prepared by mixing the individual starting materials in a batch type process. The viscosities of each of the formulations is measured at two different rates of deformation. The data in Table 1 show that Glucopon® 215UP, a C8-C10 APG according to the invention, provides advantages over other APGs having different chain lengths outside the scope of the invention and over water (e.g. nil APG). The viscosity of the formulation containing Glucopon® 215UP does not change significantly with a changing rate of deformation. The formulation containing Glucopon® 215UP is a close to Newtonian fluid, which is preferred for a liquid dishwashing composition that is unstructured. The other APGs, which have different chain lengths, as well as water (nil APG) show thixotropy, with the formulation becoming less viscous when subjected to applied stress. Thixotropic fluids may be harder to dispense and/or messier to use. At the same time, Glucopon® 215UP also provides improved foaming and detergency.

TABLE 1

| Ingredients | | | | | |
|---|---|---|---|---|---|
| (wt % as 100% active) | A | APG420 | APG600 | APG625 | Water |
| Natural C12-C14 alkyl sulfate (AS) | 10.00 | 10.00 | 10.00 | 10.00 | 10.00 |
| Glucopon ® 215 UP (C₈-C₁₀-APG) | 5.20 | 0.0 | 0.0 | 0.0 | 0.0 |
| Glucopon ® 420 UP (C₈-C₁₆-APG) | 0.0 | 5.20 | 0.0 | 0.0 | 0.0 |
| Glucopon ® 600 UP (C₁₀-C₁₆-APG) | 0.0 | 0.0 | 5.20 | 0.0 | 0.0 |
| Glucopon ® 625 UP (C₁₂, C₁₄, C₁₆-APG) | 0.0 | 0.0 | 0.0 | 5.20 | 0.0 |
| Water | 0.0 | 0.0 | 0.0 | 0.0 | 5.20 |
| Lauramidopropyl Betaine | 2.80 | 2.80 | 2.80 | 2.80 | 2.80 |
| Trisodium Citrate Dihydrate | 2.20 | 2.20 | 2.20 | 2.20 | 2.20 |
| Citric Acid Anhydrous | 1.20 | 1.20 | 1.20 | 1.20 | 1.20 |
| acetic acid | 0.045 | 0.045 | 0.045 | 0.045 | 0.045 |
| Perfume | 1.00 | 1.00 | 1.00 | 1.00 | 1.00 |
| Water & Minors | Balance | Balance | Balance | Balance | Balance |
| Total Active (Natural C12-C14 AS + Betaine + APG) | 18.00 | 18.00 | 18.00 | 18.00 | 12.8 |
| Surfactant Ratio (Natural C12-C14 AS/Betaine) | 3.57 | 3.57 | 3.57 | 3.57 | 3.57 |
| Diluted pH (10% aqueous solution) | 5.00 | 5.00 | 5.00 | 5.00 | 5.00 |
| Viscosity at 0.05 s-1 | 1,270 | 489,825 | 109,052 | 195,166 | 151,554 |
| Viscosity at 20 s-1 | 1,162 | 7,538 | 5,431 | 3,872 | 3,188 |

### Example 2—Reserve Alkalinity and Reserve Acidity of Composition A

Table 2 shows the pH, specific gravity, reserve acidity, and reserve alkalinity of Composition A (from Table 1) according to the invention.

TABLE 2
Reserve Alkalinity and Reserve Acidity

| | A |
|---|---|
| Reserve Alkalinity to pH 2 | 1.87 |
| Reserve Acidity to pH 7 as | 0.48 |
| g NaOH/100 g sample | |
| Specific Gravity | 1.04 |
| pH (neat) | 4.87 |
| pH (10% aqueous solution) | 5.01 |

Table 3 includes a range of possible formulations according to the invention. The liquid hand dishwashing detergent formulations listed in Table 3 can be prepared by mixing the individual starting materials in a batch type process.

TABLE 3

| Ingredients | | | | | |
|---|---|---|---|---|---|
| (wt % as 100% active) | A | B | C | D | E |
| Lauramidopropyl Betaine | 2.80 | 2.80 | 2.00 | 3.00 | 2.00 |
| Glucopon ® 215 UP (C₈-C₁₀-APG) | 5.20 | 3.20 | 6.50 | 5.50 | 4.00 |
| Natural C12-C14 alkyl sulfate (AS) | 10.00 | 10.00 | 7.50 | 7.50 | 10.00 |
| Trisodium Citrate Dihydrate | 2.20 | 3.07 | 2.20 | 2.20 | 2.20 |
| Citric Acid Anhydrous | 1.20 | 1.10 | 1.20 | 1.20 | 1.20 |
| acetic acid | 0.045 | 0.045 | 0.045 | 0.045 | 0.045 |
| Perfume | 1.00 | 1.00 | 1.00 | 1.00 | 1.00 |
| Water & Minors | To Balance | | | | |
| Total Active (Natural C12-C14 | 18.00 | 16.00 | 16.00 | 16.00 | 16.00 |
| AS + Betaine + APG) | | | | | |
| Surfactant Ratio (Natural C12-C14 AS/Betaine) | 3.57 | 3.57 | 3.75 | 2.50 | 5.00 |
| Diluted pH (10% aqueous solution) | 5.00 | 5.00 | 5.00 | 5.00 | 5.00 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid hand dishwashing cleaning composition comprising:
a. from about 1% to about 40% by weight of the composition of a surfactant system comprising:
i. from about 1% to about 20% by weight of the composition of an alkyl sulfate anionic surfactant of the formula R¹—O—SO₃M, wherein R¹ is a non-petroleum derived, linear fatty alcohol consisting of even numbered carbon chain lengths of from about C₆ to about C₂₀ and where M is an alkali metal, an earth alkali metal, ammonium, an alkanolamine, or mixtures thereof;
ii. from about 1% to about 15% by weight of the composition of an alkyl polyglucoside surfactant, wherein the alkyl polyglucoside surfactant has an average alkyl carbon chain length of about 8 carbon atoms to about 10 carbon atoms and a number average degree of polymerization of from about 0.5 to about 3.0;
iii. from about 1% to about 15% by weight of the composition of a zwitterionic surfactant; and
b. water;
wherein the pH of the composition is about 2 to about 7, measured as a 10% finished product solution in distilled water at 20° C.

2. The liquid hand dishwashing cleaning composition according to claim 1 wherein the composition comprises from about 0.1% to about 10% by weight of the composition of a carboxylic acid or a salt thereof selected from the group consisting of citric acid, oxalic acid, sorbic acid, acetic acid, tartaric acid, formic acid, maleic acid, adipic acid, lactic acid, malic acid, malonic acid, glycolic acid, propanoic acid, propionic acid, salicylic acid, benzoic acid, succinic acid, orthohydroxy benzoic acid, salts thereof, and mixtures thereof.

3. The liquid hand dishwashing cleaning composition according to claim 1 wherein the alkyl sulfate anionic surfactant has an average alkyl carbon chain length of about 10 carbon atoms to about 16 carbon atoms.

4. The liquid hand dishwashing cleaning composition according to claim 1, wherein at least 90% by weight of the alkyl polyglucoside surfactant has a carbon chain length of about 8 to about 10 carbon atoms.

5. The liquid hand dishwashing cleaning composition according to claim 1, wherein the weight ratio of C₈ alkyl polyglucoside to C₁₀ alkyl polyglucoside is from about 40:60 to about 60:40.

6. The liquid hand dishwashing cleaning composition according to claim 1, wherein the composition is substantially free of dyes, enzymes, polymers, or a combination thereof.

7. The liquid hand dishwashing cleaning composition according to claim 1, wherein the composition is substantially free of surfactants derived from petroleum-derived alcohols.

8. The liquid hand dishwashing cleaning composition according to claim 1, wherein the zwitterionic surfactant comprises betaine surfactant.

9. The liquid hand dishwashing cleaning composition according to claim 1, wherein the composition has about 50% transmittance or greater of light using a 1 cm cuvette at a wavelength of 410-800 nanometers.

10. The liquid hand dishwashing cleaning composition according to claim 1, wherein the composition is housed in a container that has about 25% transmittance or greater of light at a wavelength of about 410-800 nanometers.

11. The liquid hand dishwashing cleaning composition according to claim 1, wherein the weight ratio of alkyl sulfate anionic surfactant to zwitterionic surfactant is from about 1:1 to about 10:1.

12. The liquid hand dishwashing cleaning composition according to claim 1, wherein the weight ratio of alkyl sulfate anionic surfactant to alkyl polyglucoside surfactant is from about 1:1 to about 10:1.

13. The liquid hand dishwashing cleaning composition according to claim 1, wherein the weight ratio of zwitterionic surfactant to alkyl polyglucoside surfactant is from about 5:1 to about 1:5.

14. The liquid hand dishwashing cleaning composition according to claim 1, wherein the composition has a viscosity of from about 50 mPa·s to about 5,000 mPa-s, as measured on a Brookfield RT Viscometer using spindle 31, with the RPM of the viscometer adjusted to achieve a torque of between about 40% and about 60%, at about 20° C.

15. The liquid hand dishwashing cleaning composition according to claim 1, wherein the cleaning composition further comprises from about 0.01% to about 1% by weight of the composition acetic acid and/or a salt thereof.

16. The liquid hand dishwashing cleaning composition according to claim 1, wherein the composition has a reserve acidity to a pH of 7.00 of about 0.1 to about 3.

17. The liquid hand dishwashing cleaning composition according to claim 1, wherein the composition has a reserve alkalinity to a pH of 2.00 of about 1 to about 5.

18. The liquid hand dishwashing cleaning composition according to claim 1, wherein the composition comprises a bio-based carbon content of about 50% to about 100%, as derived using ASTM D6866-16.

19. A method of manually washing dishware comprising: i) delivering a liquid hand dishwashing cleaning composition according to claim 1 onto the dishware or a cleaning implement; ii) cleaning the dishware with the composition in the presence of water, and iii) optionally, rinsing the dishware.

20. A method of manually washing dishware comprising: i) providing a liquid hand dishwashing cleaning composition according to claim 1; ii) diluting said liquid hand dishwashing cleaning composition in water to obtain a wash solution, wherein the water preferably has hardness of about 6 grains per gallon to about 12 grains per gallon; and iii) washing dishware with the wash solution; iv) optionally, rinsing the dishware.
